(19) United States
(12) Patent Application Publication
(10) Pub. No.: US 2017/0016806 A1
(43) Pub. Date: Jan. 19, 2017

(54) SELF-SEALING SAMPLING PORT FOR SANITARY PIPING

(71) Applicant: Garlock Hygienic Technologies, LLC, Charlotte, NC (US)

(72) Inventor: Paul Robert Dupont, SR., Newton, NJ (US)

(21) Appl. No.: 15/212,775

(22) Filed: Jul. 18, 2016

Related U.S. Application Data
(60) Provisional application No. 62/193,200, filed on Jul. 16, 2015.

(51) Int. Cl. G01N 1/10

(52) U.S. Cl. CPC G01N 1/10; G01N 2001/1037

(57) ABSTRACT

A system is provided allowing for sanitary sampling of piping without disassembly thereof, the system having: a sampling port disposed in communication with a pipe, the sampling port having a distal portion in communication with an interior of the pipe and a proximal opening; a pressure retention ring having an open central portion, the pressure retention ring being configured to engage the proximal opening of the sampling port; and a septum disposed between the sampling port and the pressure retention ring having a lower section, an upper section and a central portion, wherein the lower section comprises an elastomeric portion of a first hardness having a diameter that is substantially the same as the interior diameter of the sampling port, wherein the upper section comprises an elastomeric portion of a second hardness having a diameter that is substantially the same as the interior diameter of the open central portion of the pressure retention ring, wherein the central portion of the septum extending from the respective diameters of the upper and lower sections substantially to the outer diameter of the pressure retention ring and substantially flat portion of the sampling port, acting as a gasket, wherein the second hardness is harder than the first hardness; wherein a sanitary sample is taken by inserting a cannula through the septum, extracting the sanitary sample and removing the cannula from the septum.

### RELATED APPLICATIONS

This application claims the benefit of U.S. Provisional Applications 62/193,200, filed Jul. 16, 2015. This application is herein incorporated by reference in its entirety for all purposes.

### FIELD OF THE INVENTION

The invention relates to sampling ports, and more particularly, to self-healing, multi-use sampling ports used in sanitary piping applications.

### BACKGROUND OF THE INVENTION

There are a variety of applications wherein it is desirable to obtain discrete or continuous samples from fluid transportation systems or fluid processing enclosures. Enclosures and fluid transportation systems, as used herein, refer to any closed containment structure without respect to its size. Thus it includes small enclosures such as cans that may be used in shipping starter bacteria from a culture lab. On the other end of the spectrum, it includes large tanks and associated pipelines, which may have capacities of several thousand gallons, such as are used in the dairy processing industry.

For sanitary fluid transport systems, the challenges posed by discrete and continuous sampling are even greater, as additional care must be taken to prevent any ingress of contaminants into the system during, or after, sampling. For this reason, efficient and effective techniques and apparatus for obtaining aseptic samples from such systems and enclosures are particularly desirable.

Examples of industries that require such aseptic sampling include, but are not limited to, the pharmaceutical, bioengineering/biotechnology, brewing/distilling, food processing and dairy processing industries. Applications for such samplings range broadly from process monitoring to laboratory and research applications.

One known method of discrete sampling of fluid involves inserting a needle through a self-healing gasket, or septum, located between connecting ends of pipelines of a fluid transportation system. Such a method typically extracts a sample size limited to the volume of a hypodermic needle and syringe. Typically the needle is inserted, fluid is drawn, and the needle is removed. Such a septum is typically constructed of an elastomeric material. Although effective, the size of the septum is generally limited, since it must be stiff enough to allow punctures by the needle, to contain the operating pressure of the system and to support any apparatuses inserted therethrough, which may impose a non-trivial load perpendicular to the septum surface, while being soft and compliant enough to conform to the device inserted therethrough and effectively seal the puncture after the needle is removed.

There are also many applications wherein it is desirable to obtain a continuous sample from fluid transportation systems or fluid processing enclosures. It would be beneficial in such applications to have a system that could draw a continuous, controlled and constant sample volume over an extended period of time. While continuous sampling techniques have been tried, they have generally not been particularly effective, efficient or reliable in maintaining the aseptic condition of the system during the sampling interval.

The placement of the punctures used in either sampling system is also of great concern. Where the punctures are too closely spaced, they may compromise the sealing integrity or strength of the septum or allow the introduction of contaminants into the system through the perforations. Conversely, when the punctures are spaced too far apart the septum may have to be replaced more frequently than if spacing was optimized, resulting in higher running costs and unnecessary downtime.

A further problem with such systems is the use of an exposed needle or other sharp object to perforate the septum, which may pose a health hazard to the sampler of such systems in the case of systems containing potential biohazards. The needle or other object used to puncture the septum may also allow for the inadvertent introduction of the sample into the sampler if great care is not taken.

What is needed, therefore, are techniques for providing a septum having a large self-healing surface area that provides the structural stiffness necessary to accommodate continuous sampling instruments and loads imposed by insertion of such equipment through the septum while improving on the aseptic qualities of the septum, techniques for reducing or eliminating the risk of contamination by biohazards to a sampler due to needle-sticks and techniques for directing placement of punctures on the septum to maximize the useful life and integrity of the septum over the course of that useful life.

### SUMMARY OF THE INVENTION

One embodiment of the present invention provides a system allowing for sanitary sampling of piping without disassembly thereof, the system having: a sampling port disposed in communication with a pipe, the sampling port having a distal portion in communication with an interior of the pipe and a proximal opening; a pressure retention ring having an open central portion, the pressure retention ring being configured to engage the proximal opening of the sampling port; and a septum disposed between the sampling port and the pressure retention ring having a lower section, an upper section and a central portion, wherein the lower section comprises an elastomeric portion of a first hardness having a diameter that is substantially the same as the interior diameter of the sampling port, wherein the upper section comprises an elastomeric portion of a second hardness having a diameter that is substantially the same as the interior diameter of the open central portion of the pressure retention ring, wherein the central portion of the septum extending from the respective diameters of the upper and lower sections substantially to the outer diameter of the pressure retention ring and substantially flat portion of the sampling port, acting as a gasket, wherein the second hardness is harder than the first hardness; wherein a sanitary sample is taken by inserting a cannula through the septum, extracting the sanitary sample and removing the cannula from the septum.

Another embodiment of the present invention provides such a system allowing for sanitary sampling of piping further having a supporting disk having a plurality of apertures therethrough, wherein the supporting disk is disposed in the central portion of the septum.

A further embodiment of the present invention provides such a system allowing for sanitary sampling of piping without disassembly thereof wherein the pressure retention ring further comprises markings about an upper surface thereof which are substantially equally spaced about its peripheral region.

Still another embodiment of the present invention provides such a system allowing for sanitary sampling of piping without disassembly thereof wherein the septum further comprises a substantially raised portion disposed on first and second surfaces of the central portion, where the first and second surfaces are perpendicular to a major axis of the proximal opening, so as to engage at least one channel disposed in the pressure retention ring and/or sampling port.

One embodiment of the present invention provides a septum, the septum having: a first section having an elastomeric portion of a first hardness, wherein the first section is designed to be in contact with the interior volume of an apparatus from which a sample is to be extracted; and a second section having an elastomeric portion of a second hardness; wherein a sample is taken by inserting a cannula through the septum, extracting the sample and removing the cannula from the septum.

Another embodiment of the present invention provides such a further having a central portion having a flange extending from a circumferential edge of the septum and disposed between the upper and lower sections of the septum.

A further embodiment of the present invention provides such a septum wherein the flange further comprises a substantially raised portion disposed concentrically about the septum.

Still another embodiment of the present invention provides such a septum wherein the second hardness is harder than the first hardness.

A still further embodiment of the present invention provides such a septum wherein the first hardness is between 50-100 using the Shore A scale and the second hardness is between 20-60 using the Shore A scale.

Yet another embodiment of the present invention provides such a septum wherein the first hardness is 80 using the Shore A scale and the second durometer is 40 using the Shore A scale.

A yet further embodiment of the present invention provides such a septum further having a support disk embedded therein, substantially between the upper and lower septum sections, wherein the support disk is made of a relatively inflexible material and further comprises a plurality of apertures therethrough.

Even another embodiment of the present invention provides such a septum wherein the support disk is made of stainless steel.

An even further embodiment of the present invention provides such a septum wherein the support disk is 3/16″ in thickness.

Yet still another embodiment of the present invention provides such a septum wherein the support disk apertures are shaped to accommodate the stems of instruments inserted therethrough, thereby reducing the sideways forces transmitted to the elastomeric portions of the septum.

A yet even further embodiment of the present invention provides such a septum wherein the upper septum section is of a smaller diameter than the lower septum section.

One embodiment of the present invention provides an improved needleless septum and sampling device having: a septum having an upper section and a lower section, wherein the upper section comprises a central section that is substantially recessed, the substantially recessed central section itself being surrounded by a further recessed region, the further recessed region being surrounded at its outer periphery by an upper section of septum substantially higher than the central section; a cannula having a distal portion extending through the septum lower section and a proximal portion disposed centrally in the upper septum section, adjacent an upper surface thereof; and a needleless septum sampling device having a sample container, having, at one end, a puncturable, self-sealing element sealingly fixed thereto, wherein the puncturable, self-sealing element has a profile corresponding to that of the further recessed region surrounding the substantially recessed central section of the septum upper section, allowing the puncturable, self-sealing element to be inserted into the central section of the septum upper section and exert pressure on the upper surface of the central section of the septum, thereby allowing the cannula to protrude through the central portion of the septum and the puncturable, self-sealing element, allowing communication between an interior portion of an apparatus to be sampled and the sample container.

Another embodiment of the present invention provides such a needleless septum and sampling device wherein the cannula further comprises a section of substantially larger diameter than a body thereof, the section of substantially larger diameter positioned adjacent the proximal end of the cannula and within the septum, wherein the section of substantially larger diameter serves to resist motion of the cannula relative to the septum during sampling.

A further embodiment of the present invention provides such a needleless septum and sampling device wherein the distal portion of the cannula is substantially centered within a flow path of an interior volume of the apparatus to be sampled.

Still another embodiment of the present invention provides such a needleless septum and sampling device wherein the septum upper section is harder than the septum lower section.

Yet another embodiment of the present invention provides such a needleless septum and sampling device wherein the sample container is evacuated.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a side elevation view of an angled section of sanitary piping including a sampling port wherein a needle is inserted therein, a distal portion of which is in communication with an interior of the sanitary piping, in accordance with one embodiment of the present invention;

FIG. 1B is a section view of the embodiment of FIG. 1A;

FIG. 2 is a perspective view of an angled section of sanitary piping including a sampling port having a reinforcing member wherein a needle is inserted therein, a distal portion of which is in communication with an interior of the sanitary piping, in accordance with one embodiment of the present invention;

FIG. 3 is a top view of the section of sanitary piping of FIG. 2;

FIG. 4 is a top view of a sanitary fitting having a reinforcing member which is secured via a band style clamp, in accordance with one embodiment of the present invention;

FIG. 5A is a bottom exploded perspective view of a multi-use sampling port membrane having a reinforcing member and pressure retention ring, in accordance with one embodiment of the present invention;

FIG. 5B is a top exploded perspective view of the multi-use sampling port membrane having a reinforcing member and pressure retention ring of FIG. 5A;

FIG. 6 is a sampling port membrane pressure retention ring having markings thereon, in accordance with one embodiment of the present invention;

FIG. 7 is a side elevation view of a sampling port membrane, in accordance with one embodiment of the present invention;

FIG. 8A is an exploded side elevation view of a sampling port in a sanitary pipe having a three part multi-use sanitary membrane and pressure retention ring, in accordance with one embodiment of the present invention;

FIG. 8B is an exploded side elevation view of the sampling port of FIG. 8A showing the detail of a reinforcing member sandwiched between top and bottom portions of the sanitary membrane;

FIG. 9 is a sanitary pipe having multiple sampling ports therein, in accordance with one embodiment of the present invention;

FIG. 10 is a side elevation section view of a sanitary pipe having a sampling port designed for needleless sampling, in accordance with one embodiment of the present invention;

FIG. 11A is a side elevation section view with detail view of a sanitary pipe having a sampling port designed for needleless sampling wherein the sampling port is in a closed position, in accordance with one embodiment of the present invention;

FIG. 11B is a side elevation section view with detail view of a sanitary pipe having a sampling port designed for needleless sampling wherein the sampling port is in a closed position, in accordance with one embodiment of the present invention;

FIG. 12A is a side elevation view of a needless elastomeric gasket, in accordance with one embodiment of the present invention;

FIG. 12B is a side elevation view of the needless elastomeric gasket of FIG. 12A, in accordance with one embodiment of the present invention; and

FIG. 12C is a perspective view of a needle incorporated into the needleless elastomeric septum of FIGS. 12A and 12B.

### DETAILED DESCRIPTION

The following description should be read with reference to the drawings wherein like reference numerals indicate like elements throughout the several views. The detailed description and drawings show several embodiments which are meant to be illustrative of the claimed invention.

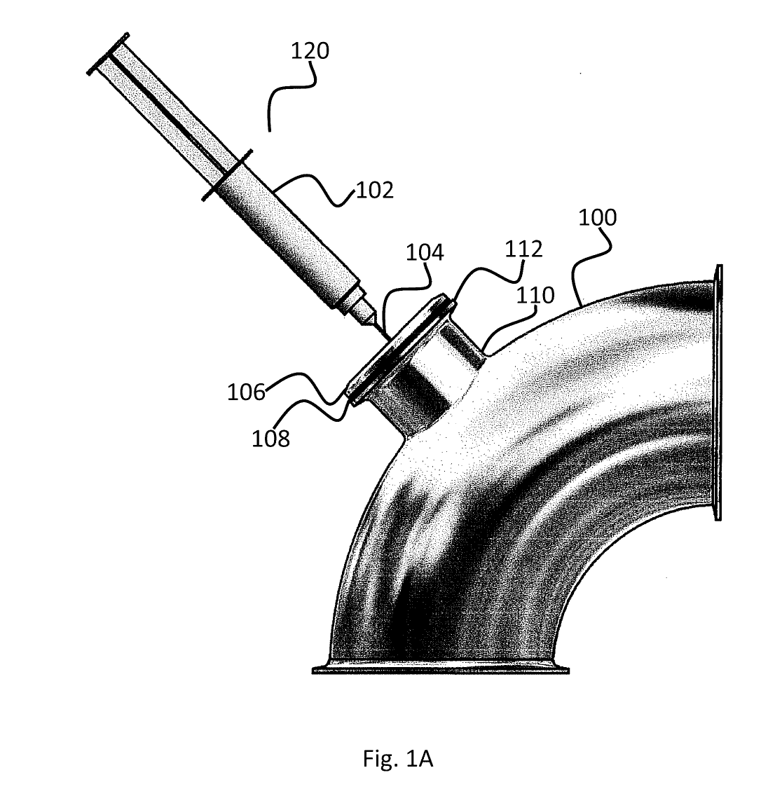

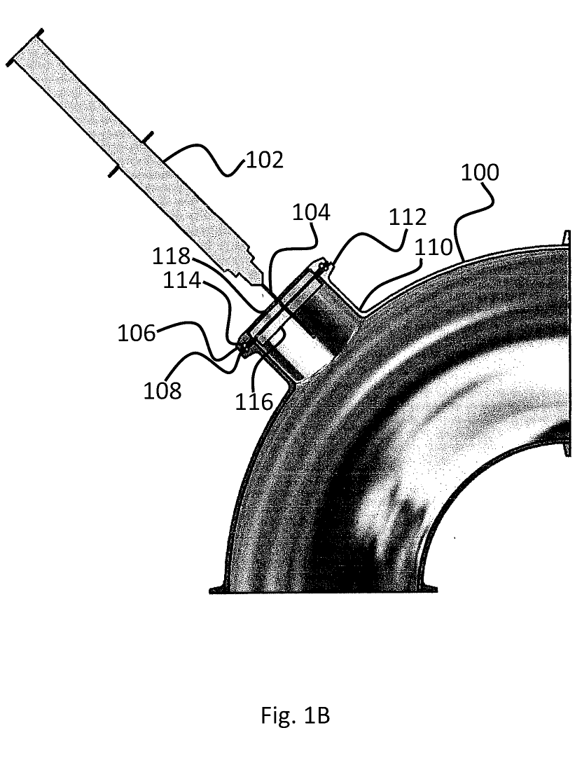

FIGS. 1A and 1B show side elevation views of an angled section of piping 100, which, in embodiments, may be sanitary piping 100, including a sampling port 110 having a septum disposed therein, wherein, in use, a needle 120 comprising cannula 104 and syringe 102 portions, is inserted into the sampling port 110 and through the septum 108, a distal portion of which, when fully inserted, enters into communication with an interior of the piping 100. In this embodiment, a pressure retention ring 106 is used to hold the septum 108, in sealing engagement with an upper piping flange 112 of the sampling port 110. In embodiments, the septum 108 may be made of an elastomeric material.

FIG. 1B is a section view of the embodiment of FIG. 1A showing the interior details of this embodiment. From this view, it can be seen that the septum 108 has an upper septum section 118, in communication with the atmosphere external to the piping 100, and a lower septum section 116, in communication with an interior chamber of the pipe 100. In embodiments, these septum 108 sections may be of different thicknesses, materials, and durometer.

In embodiments, the upper septum section 118 may be made of a material having a Shore A hardness of between 50-100 while the lower septum section 116 may be made of a material having a Shore A hardness of between 20-60. One example of such an embodiment has an upper septum section 118 having a Shore A hardness of 80, while the lower septum section 116 has a Shore A hardness of 40. In general, the upper septum section 118 hardness should be greater than that of the lower section 116 to provide the desired benefits of such a design.

One of the benefits of such a design includes increased resistance to inadvertent puncture and environmental contamination resulting therefrom while maintaining or enhancing the self-healing ability of the septum 108 as compared to previous designs by allowing the use of softer compounds for the lower septum section 116 that is in direct communication with the interior chamber of the pipe 100 than would previously have been feasible. Another benefit of the design is increased pressure holding ability within the piping 100. Still another benefit of the design is an enhanced ability of the septum 108 to hold relatively heavy instruments therein by preventing enlargement of the septum 108 puncture made by the instrument due to side loads imposed by such equipment over time, such instruments typically used for extended or continuous monitoring of conditions internal to the pipe 100. In previous septum 108 arrangements, where the entire septum 108 was made of a relatively soft material to allow for self-sealing, this lack of stiffness tended to allow for tearing of the septum or elongation of the opening created by the instrument inserted therethrough, in both cases compromising the integrity of the pipe 100; such failure being a significant concern, especially in sanitary piping applications.

In embodiments, disposed between the central portion of the upper septum section 118 and lower septum section 116 and extending therefrom is a substantially thinner section 500 of septum 108 which extends outwards from the central portion of the septum 108 to form a gasket 500. This gasket portion 500 may be interchangeably referred to herein as a flange 500 and, in embodiments, is sandwiched between a pressure retention ring 106 and an upper piping flange 112. The gasket 500 may also incorporate a substantially raised portion 502 that is, in embodiments, concentric with the central portion of the septum 108, and configured to engage with corresponding channels 114 in the pressure retention ring 106 and upper piping flange 112 to better seal the sampling port 110. The substantially raised portion or portions 502, in embodiments, may be sized slightly larger than the corresponding channels 114 of the pressure retention ring 106 and upper piping flange 112 to enhance the seal provided by such an arrangement. In other embodiments, the flange 500 may be integrally formed from one or the other of the septum sections 116/118, as opposed to being a separate section.

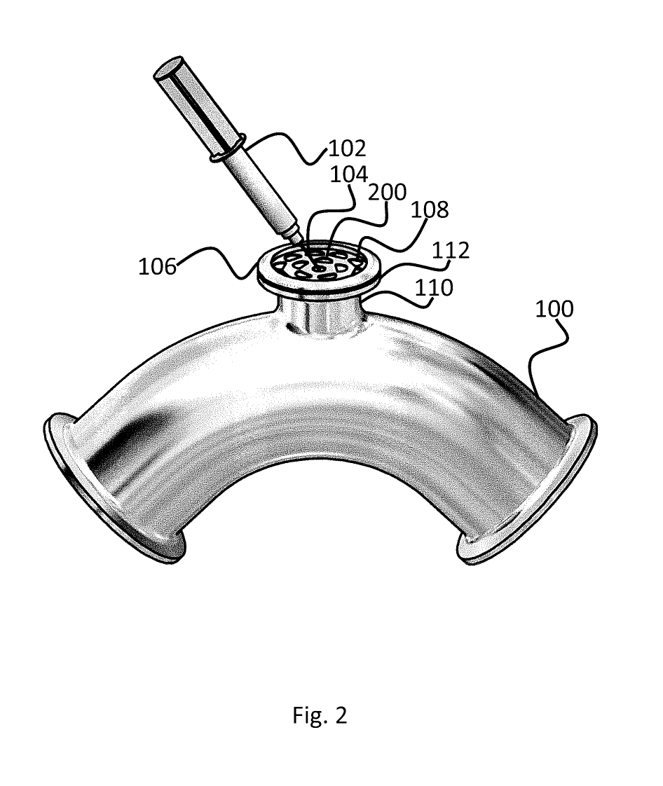

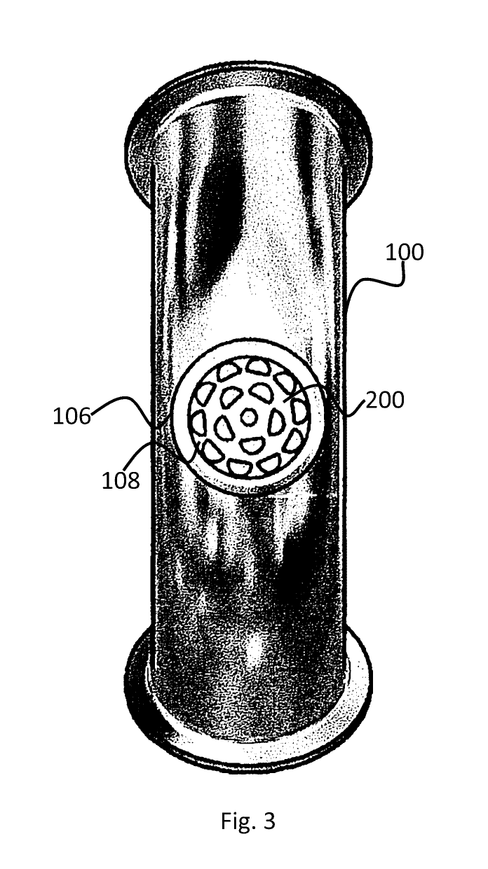

Now referring to FIGS. 2 and 3, an embodiment of the present invention wherein the septum 108 includes a support disk 200 placed between the upper septum section 118 and lower septum section 116 is shown. The support disk 200 provides increased resistance to inadvertent puncture and environmental contamination resulting therefrom while maintaining or enhancing the self-healing ability of the septum 108 as compared to previous designs by allowing the use of softer compounds for the lower septum section 116 that is in direct communication with the interior chamber of the pipe 100 than would previously have been feasible. Another benefit of the design is increased pressure holding ability within the piping 100.

In other embodiments, the support disk 200 may include slots therethrough, such slots serving multiple purposes. First and foremost, the slots allow entry of an instrument through both the upper septum section 118 and lower septum section 116, allowing use of the sampling port 110 using traditional instruments. In some embodiments, however, the slots may serve as targets during perforation to guide a user as to the intended target locations, maximizing the useful life of the septum by optimizing the spacing of subsequent perforations therethrough while providing a quick visual indication of the remaining life of the septum 108. In embodiments, such slots are shaped to accommodate specific instruments, minimizing the stress on the elastomeric portions of septum 108 and allowing the use of softer materials, with improved self-sealing abilities, to be used in its construction. In embodiments the support disk 200 may be made of stainless steel, polymers, metals or other suitable materials. Although a circular disk is illustrated, a support disk 200, in embodiments, may be of any suitable shape. In one exemplary embodiment, the support disk 200 is constructed of 3/16″ stainless steel and substantially circular in shape.

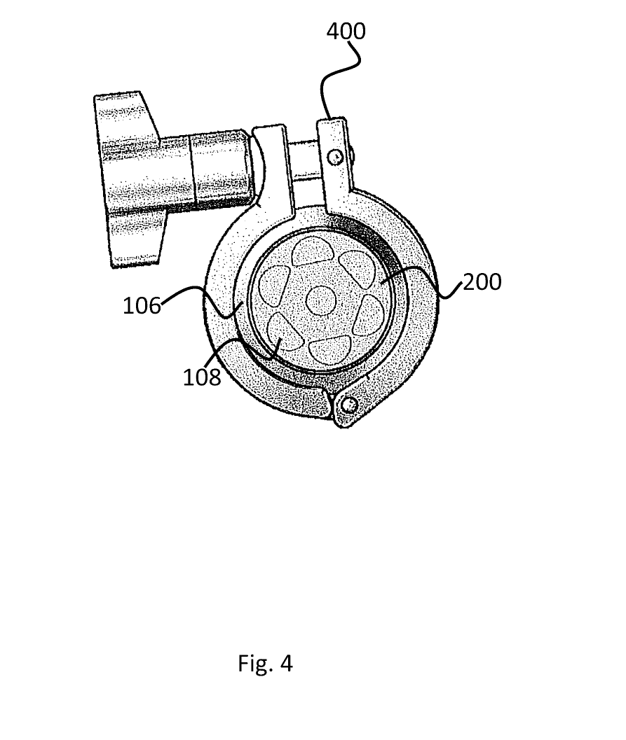

Now referring to FIG. 4, a clamp style retention system 400 comprising a circular clamp having a groove in which the pressure retention ring 106 and upper piping flange 112 of the present invention are captured and a hinge allowing for opening and closing of the clamp positioned opposite a threaded fastening system for securing a first hinged half of the clamp to a second hinged half of the clamp is shown. It should be noted that there are many ways that would be obvious to one having ordinary skill in the art to secure the pressure retention ring 106 and septum 108 combinations to the sampling port 110 of a pipe 100. This example is merely illustrative of one such method.

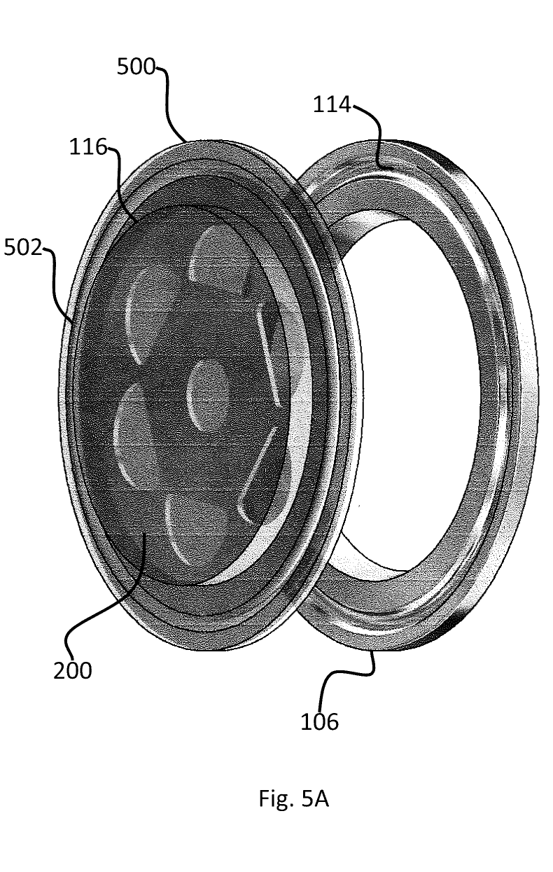

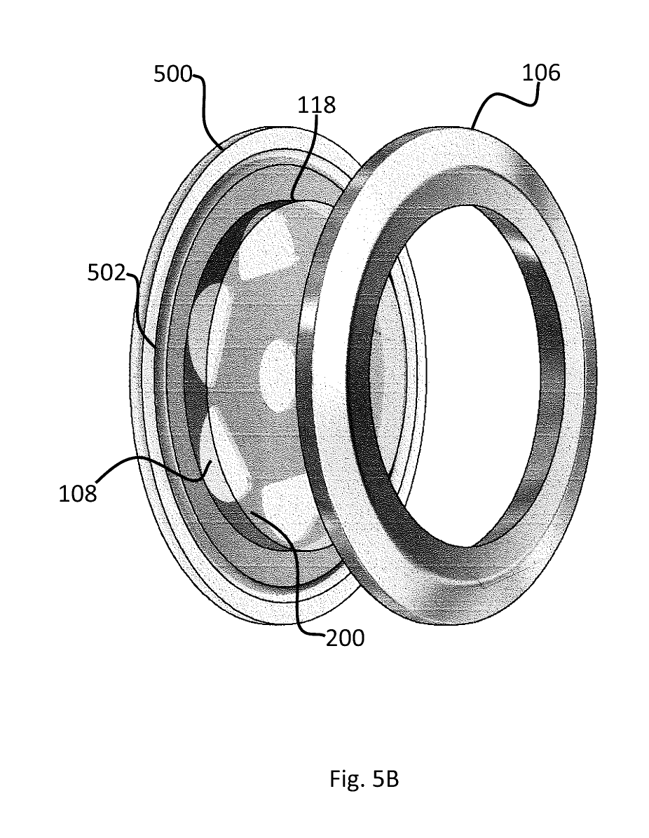

FIGS. 5A and 5B show the septum 108 and pressure retention ring 106 in a bottom perspective view and top perspective view, respectively. In FIG. 5A, the septum 108, specifically the lower septum section 116, support disk 200, and pressure retention ring 106 with channel 114, designed to accommodate the substantially raised portion of the septum 108 gasket concentric with the central portion thereof, are shown, in accordance with one embodiment of the present disclosure. FIG. 5B further shows the upper septum section 118 and the top of the pressure retention ring 106, in accordance with one embodiment of the present disclosure.

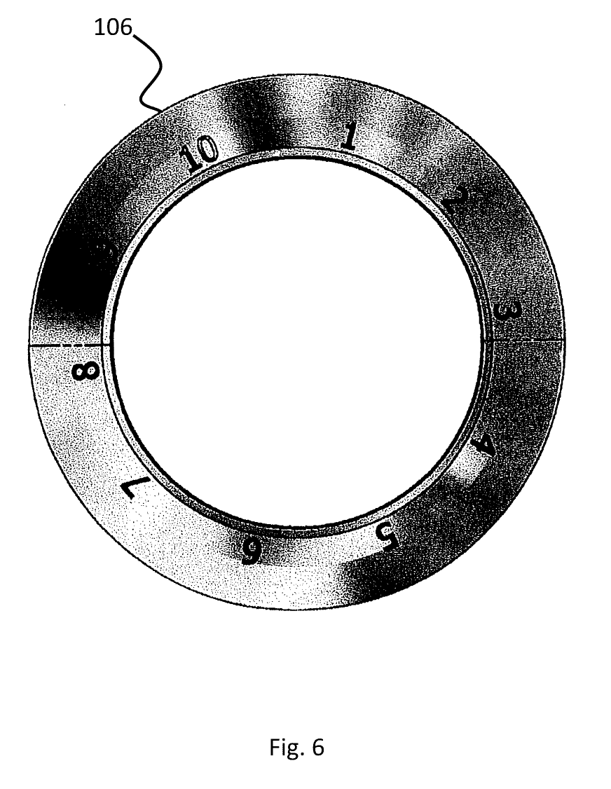

FIG. 6 illustrates another embodiment of the pressure retention ring 106. In this embodiment, markings, which may comprise numbers, letters, symbols or combinations thereof, are disposed substantially equally around the circumference of the pressure retention ring 106. This marking allows for more accurate record keeping of septum 108 punctures and can also provide a visual indication that the pressure retention ring 106 has shifted from its initially installed position, which may be used as an indication that the system's integrity has been compromised.

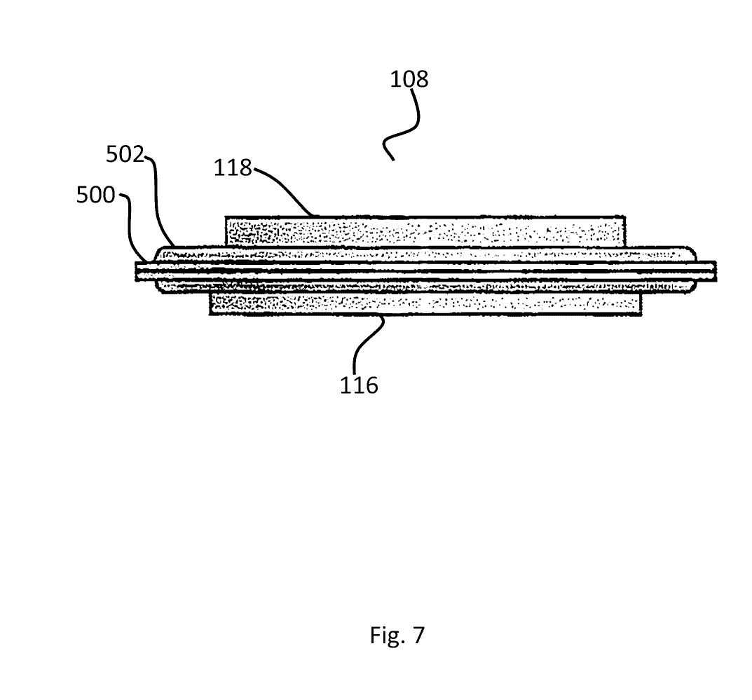

FIG. 7 is a side elevation view of the septum 108, showing the upper septum section 118 and lower septum section 116 as well as the substantially raised portion of the septum 108 gasket concentric with the central portion thereof. The septum 108, in embodiments, may be manufactured using insert molding injection molding techniques, injection molding combined with ultrasonic welding, casting, or other suitable techniques.

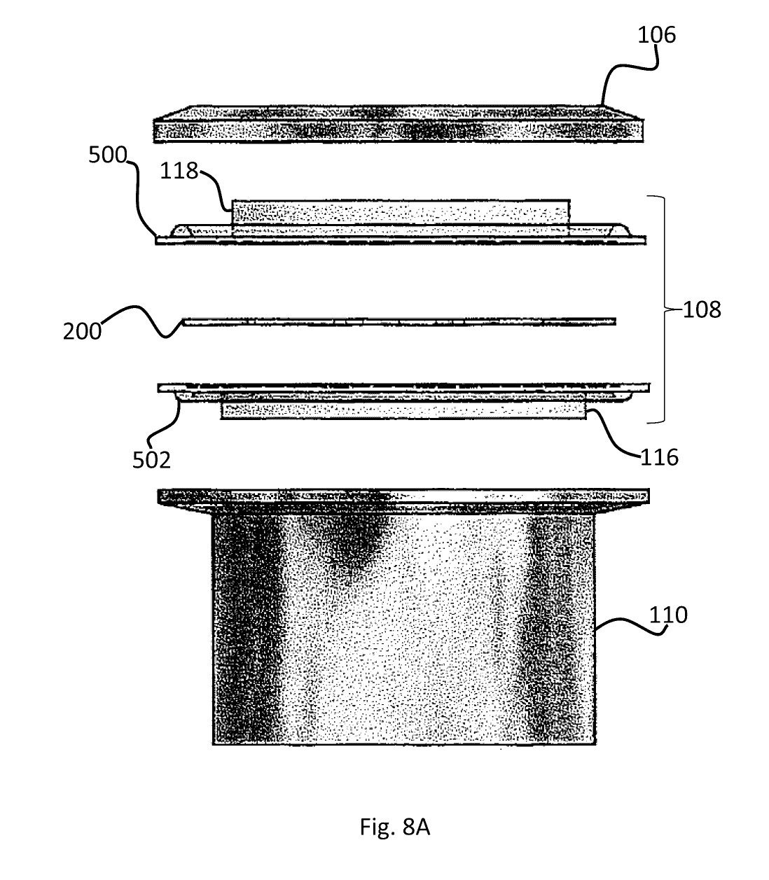

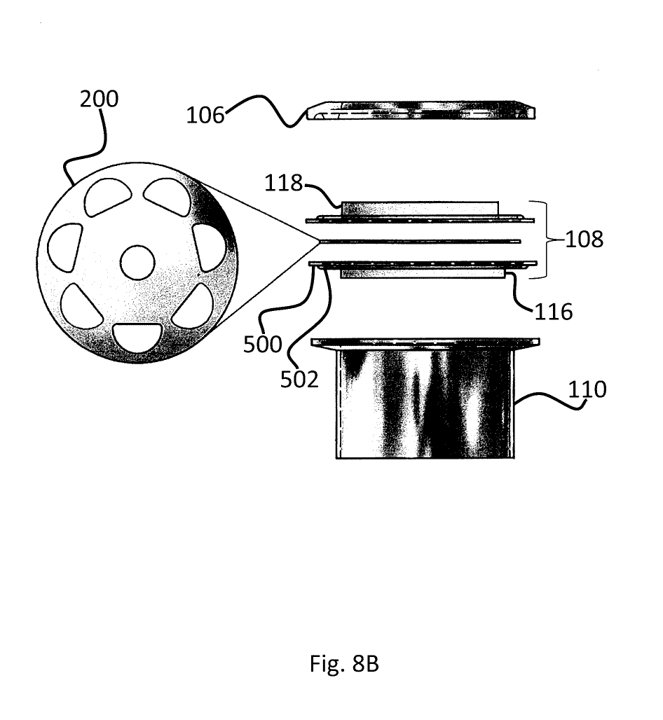

Now referring to FIGS. 8A and 8B, a sampling port 110, pressure retention ring 106, upper septum section 118, lower septum section 118 and support disk 200 are shown in exploded view. FIG. 8B also includes a detail view better showing the support disk 200 of FIG. 8A, in accordance with embodiments of the present invention.

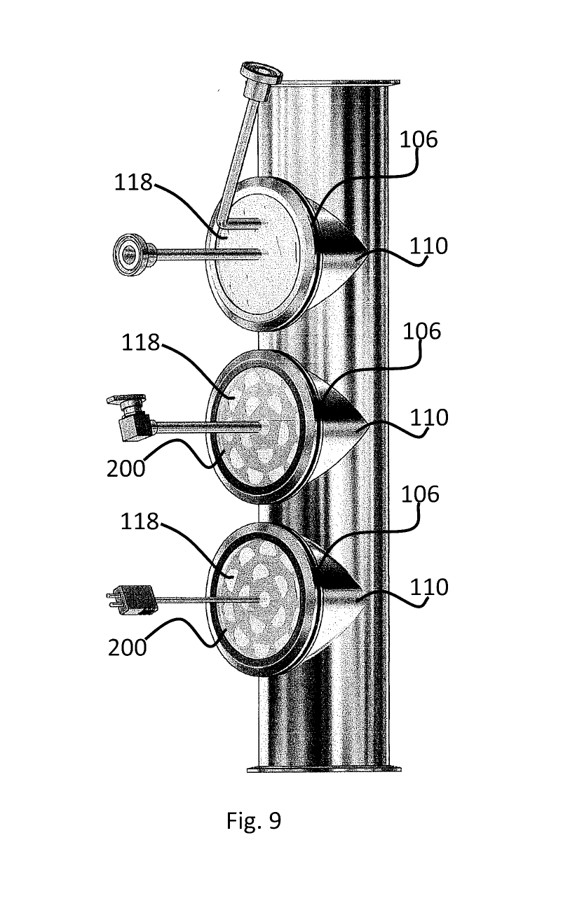

As shown in FIG. 9, a variety of instruments may be used in conjunction with the sampling port 110 of the present disclosure, including those used for long term and substantially continuous sampling. A single pipe 100 may also accommodate many such sampling ports 110.

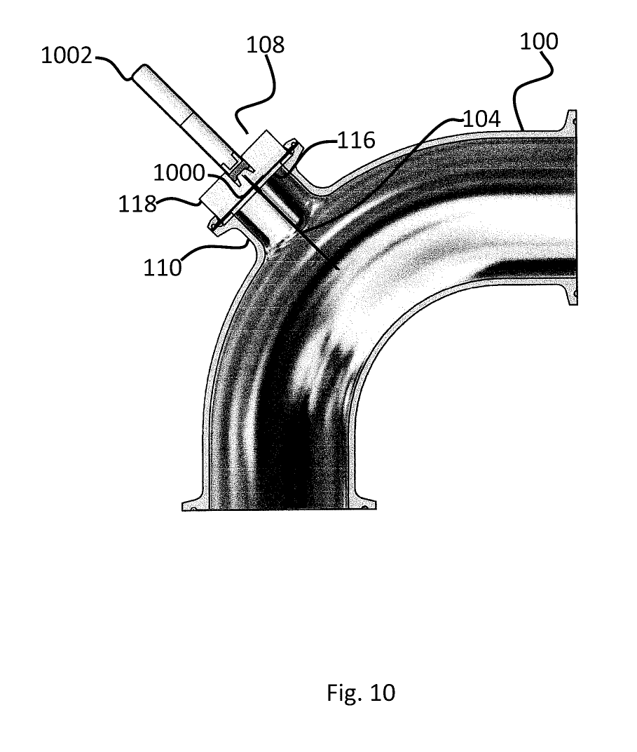

FIG. 10 is a side elevation section view showing a needleless embodiment of the present disclosure. In this embodiment, the cannula 104 resides within the sampling port 110 at all times. The cannula 104 of this embodiment includes a support ring 1000 that is positioned adjacent the cannula 104 end proximal to the side of the septum 108 exposed to the atmosphere outside of the pipe 100. The support ring 1000 of the cannula 104 is manufactured as a part of the cannula 104 or fixed permanently thereto, in embodiments, and serves to resist motion of the cannula 104 relative to the septum 108 during sampling. In embodiments, the cannula 104 is positioned such that a distal portion thereof is substantially centered within the flow path of the piping 100 and a proximal portion thereof is disposed centrally in and adjacent the surface of the upper septum section 118. Surrounding such central portion is a substantially lower section of septum 108, which itself, in embodiments, is surrounded by a section of septum substantially higher than the central section. A needleless septum sampling device 1002 having a corresponding, profile allowing its insertion into the central area of the septum 108 and incorporating a puncturable, self-sealing bottommost portion may then be used, in embodiments, to allow for the taking of samples without the use of an exposed needle 120. When the needleless septum sampling device 1002 is inserted into the central area of the septum, the substantially lowered section of the septum 108 surrounding the central portion thereof allows the needleless septum sampling device 1002 to place pressure on the central portion of the septum 108, causing the cannula 104 to protrude through the central portion of the septum 108. Further pressure on the needleless septum sampling device 1002 then allows the cannula 104 to penetrate the needleless septum sampling device 1002, allowing communication between an interior portion of the pipe 100 and the needleless septum sampling device 1002. While the embodiment shown is circular, any shape could be used, assuming the profile of the needleless septum sampling device 1002 is complimentary thereto. In embodiments, the needleless septum sampling device 1002 may be evacuated, resulting in a facilitation of the flow of a sample therein.

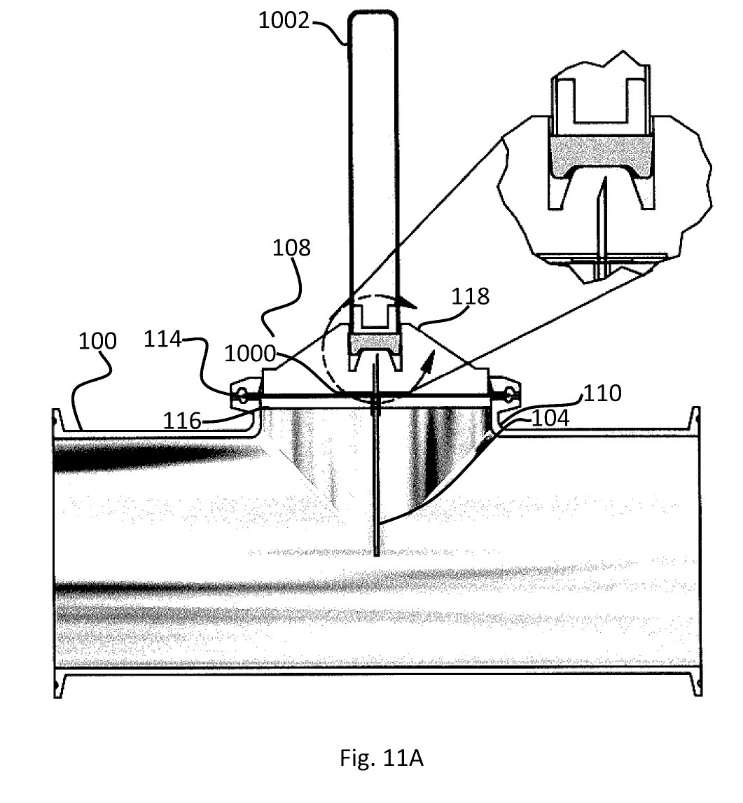

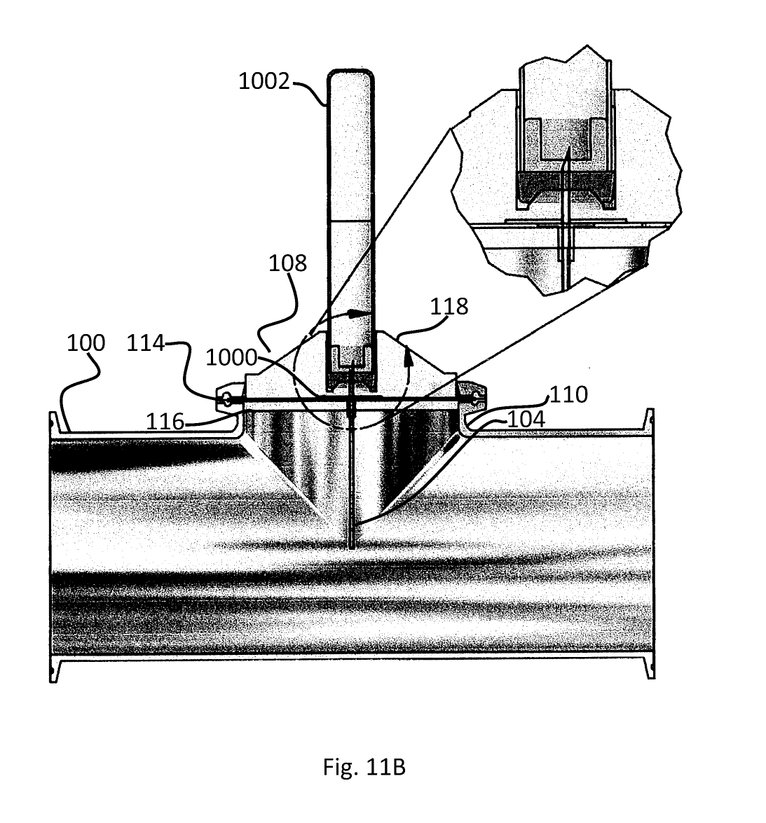

Now referring to FIGS. 11A and 11B, side elevation sectional views showing an embodiment of the needleless embodiment of the present disclosure in a ready to sample and sampling state, respectively, are shown. These figures, in addition to showing the operation of the device, also show its incorporation of the support disk 200, two part septum 108 (an upper septum section 118 and lower septum section 116), septum 108 gasket channel 114 and pressure retention ring 106 of previously described embodiments, providing the benefits thereof, as previously discussed.

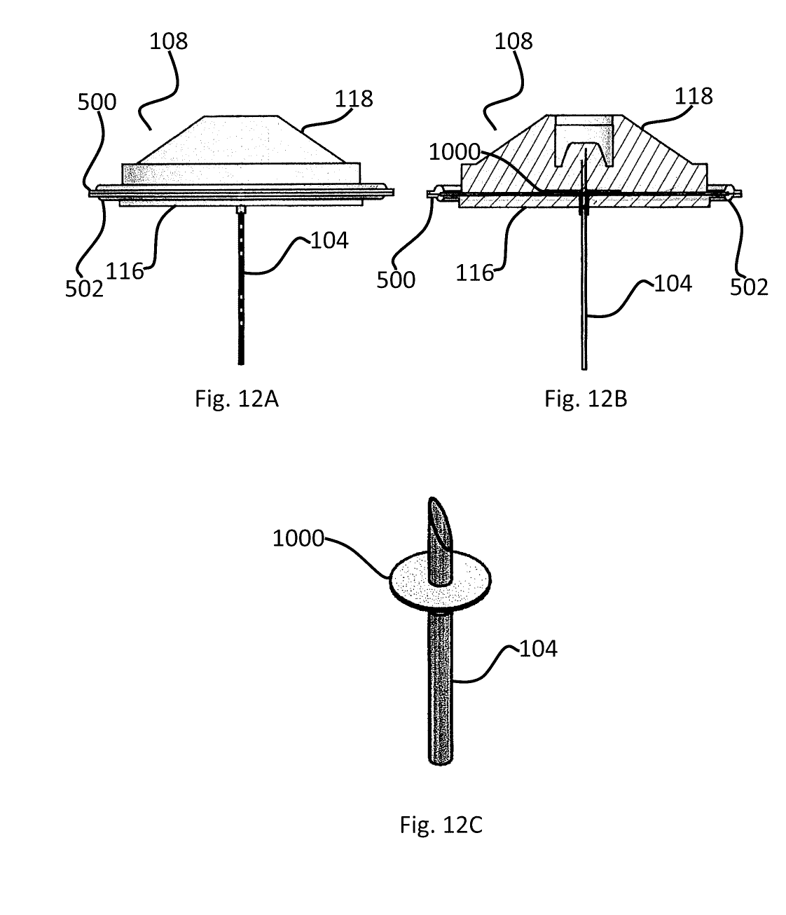

FIGS. 12A, 12B and 12C show the needleless septum 108 embodiment in side elevation view, side elevation section view and the cannula 104 having support ring 1000 previously discussed in greater detail outside of the pipe 100 and sampling port 110.

One embodiment of the present invention provides a system allowing for sanitary sampling of piping without disassembly thereof, as disassembly would potentially lead to contamination of the system and, whether contamination is present or not, would require recertification as to the sanitary status of the system, the system comprising: a pipe comprising a sampling port, the sampling port comprising a distal portion in communication with an interior of the pipe and a proximal portion having a substantially flat portion extending substantially perpendicularly outwards from an interior volume thereof; a pressure retention ring comprising an open central portion and a substantially flat lower peripheral section, wherein the open central portion is substantially similar, or smaller, in size and shape to an interior diameter of the sampling port and the edge section is substantially similar, or larger, in size and shape to the substantially flat portion of the sampling port; and a septum disposed between the sampling port and the pressure retention ring comprising a lower section, an upper section and a central portion, wherein the lower section comprises an elastomeric portion of a first hardness having a diameter that is substantially the same as the interior diameter of the sampling port, wherein the upper section comprises an elastomeric portion of a second hardness having a diameter that is substantially the same as the interior diameter of the open central portion of the pressure retention ring, wherein the central portion of the septum comprises a substantially thinner section extending from the respective diameters of the upper and lower sections substantially to the outer diameter of the pressure retention ring and substantially flat portion of the sampling port, acting as a gasket, wherein the second hardness is harder than the first hardness; wherein a sanitary sample is taken by inserting a cannula through the septum, extracting the sanitary sample and removing the cannula from the septum. In such a system there may be a supporting disk comprising a plurality of apertures therethrough, wherein the supporting disk is centrally positioned in the central portion of the septum. The pressure retention ring may further comprise markings located around an upper surface thereof which are substantially equally spaced about its peripheral region. Such a septum may also include a substantially raised portion disposed concentrically about the substantially thinner section of the central portion and the pressure retention ring and sampling port further comprise a channel designed to accommodate the substantially raised portion.

An improved septum configured according to one embodiment of the present invention comprises a lower section comprising an elastomeric portion of a first hardness, wherein the lower section is designed to be in contact with the interior volume of an apparatus to be sampled; and an upper section comprising an elastomeric portion of a second hardness; wherein a sanitary sample is taken by inserting a cannula through the septum, extracting the sanitary sample and removing the cannula from the septum. Such a septum may include a central portion comprising an elastomeric section that is substantially thinner than the upper and lower sections of the septum, the central elastomeric section extending from the respective diameters of the upper and lower sections, wherein it may act as a gasket. The septum according to such an embodiment may have a substantially thinner portion of the central elastomeric section further comprises a substantially raised portion disposed concentrically about the septum. Such a septum may be provided wherein the second hardness is harder than the first hardness, in one embodiment, the first hardness is between 50-100 using the Shore A scale and the second hardness is between 20-60 using the Shore A scale, and in one embodiment the first hardness is 80 using the Shore A scale and the second durometer is 40 using the Shore A scale. Such a septum may have a support disk embedded therein, substantially between the upper and lower septum sections, wherein the support disk is made of a relatively inflexible material and further comprises a plurality of apertures therethrough. The support disk may be made of stainless steel or other suitable material, and can be 3/16″ in thickness.

Such support disk apertures, in some embodiments are shaped to accommodate the stems of instruments inserted therethrough, thereby reducing the sideways forces transmitted to the elastomeric portions of the septum.

In various embodiments, the septum may be configured with the upper septum section is thinner than the lower septum section and/or the upper septum section is of a smaller diameter than the lower septum section.

In one embodiment of the present invention provides an improved needleless septum and sampling device comprising: a septum comprising an upper section and a lower section, wherein the upper section comprises a central section that is substantially recessed, the substantially recessed central section itself being surrounded by a further recessed region, the further recessed region being surrounded at its outer periphery by an upper section of septum substantially higher than the central section; a cannula comprising a distal portion extending through the septum lower section and a proximal portion disposed centrally in the upper septum section, adjacent an upper surface thereof; and a needleless septum sampling device comprising a sample container, such as a test tube or evacuated sample tube, having, at one end, a puncturable, self-sealing element sealingly fixed thereto, wherein the puncturable, self-sealing element has a profile corresponding to that of the further recessed region surrounding the substantially recessed central section of the septum upper section, allowing the puncturable, self-sealing element to be inserted into the central section of the septum upper section and exert pressure on the upper surface of the central section of the septum, thereby allowing the cannula to protrude through the central portion of the septum and the puncturable, self-sealing element, allowing communication between an interior portion of an apparatus to be sampled and the sample container.

One such embodiment of the present invention provides such an improved needleless septum and sampling device wherein the cannula further comprises a section of substantially larger diameter than a body thereof, the section of substantially larger diameter positioned adjacent the proximal end of the cannula and within the septum, wherein the section of substantially larger diameter serves to resist motion of the cannula relative to the septum during sampling. An improved needleless septum and sampling device configured according to one embodiment may be configured with a distal portion of the cannula that is substantially centered within a flow path of an interior volume of the apparatus to be sampled and a septum upper section which is harder than the septum lower section.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A system allowing for sanitary sampling of piping without disassembly thereof, the system comprising:
a sampling port disposed in communication with a pipe, said sampling port comprising a distal portion in communication with an interior of said pipe and a proximal opening;
a pressure retention ring comprising an open central portion, said pressure retention ring being configured to engage said proximal opening of said sampling port; and
a septum disposed between said sampling port and said pressure retention ring comprising a lower section, an upper section and a central portion, wherein said lower section comprises an elastomeric portion of a first hardness having a diameter that is substantially the same as said interior diameter of said sampling port, wherein said upper section comprises an elastomeric portion of a second hardness having a diameter that is substantially the same as the interior diameter of said open central portion of said pressure retention ring, wherein said central portion of said septum extending from the respective diameters of said upper and lower sections substantially to the outer diameter of the pressure retention ring and substantially flat portion of said sampling port, acting as a gasket, wherein said second hardness is harder than said first hardness;
wherein a sanitary sample is taken by inserting a cannula through said septum, extracting said sanitary sample and removing said cannula from said septum.

2. The system allowing for sanitary sampling of piping without disassembly thereof of claim 1 further comprising a supporting disk comprising a plurality of apertures therethrough, wherein said supporting disk is disposed in said central portion of said septum.

3. The system allowing for sanitary sampling of piping without disassembly thereof of claim 1 wherein said pressure retention ring further comprises markings about an upper surface thereof which are substantially equally spaced about its peripheral region.

4. The system allowing for sanitary sampling of piping without disassembly thereof of claim 1 wherein said septum further comprises a substantially raised portion disposed on first and second surfaces of said central portion, where said first and second surfaces are perpendicular to a major axis of said proximal opening, so as to engage at least one channel disposed in said pressure retention ring and/or sampling port.

5. A septum, said septum comprising:
a first section comprising an elastomeric portion of a first hardness, wherein said first section is designed to be in contact with the interior volume of an apparatus from which a sample is to be extracted; and
a second section comprising an elastomeric portion of a second hardness;
wherein a sample is taken by inserting a cannula through said septum, extracting said sample and removing said cannula from said septum.

6. The septum of claim 5 further comprising a central portion comprising a flange extending from a circumferential edge of said septum and disposed between said upper and lower sections of said septum.

7. The septum of claim 6 wherein said flange further comprises a substantially raised portion disposed concentrically about said septum.

8. The septum of claim 5 wherein said second hardness is harder than said first hardness.

9. The septum of claim 5 wherein said first hardness is between 50-100 using the Shore A scale and said second hardness is between 20-60 using the Shore A scale.

10. The septum of claim 5 wherein said first hardness is 80 using the Shore A scale and said second durometer is 40 using the Shore A scale.

11. The septum of claim 5 further comprising a support disk embedded therein, substantially between said upper and lower septum sections, wherein said support disk is made of a relatively inflexible material and further comprises a plurality of apertures therethrough.

12. The septum of claim 11 wherein said support disk is made of stainless steel.

13. The septum of claim 12 wherein said support disk is 3/16″ in thickness.

14. The septum of claim 11 wherein said support disk apertures are shaped to accommodate the stems of instruments inserted therethrough, thereby reducing the sideways forces transmitted to the elastomeric portions of said septum.

15. The septum of claim 5 wherein said upper septum section is of a smaller diameter than said lower septum section.

16. An needleless septum and sampling device comprising:
a septum comprising an upper section and a lower section, wherein said upper section comprises a central section that is substantially recessed, said substantially recessed central section itself being surrounded by a further recessed region, said further recessed region being surrounded at its outer periphery by an upper section of septum substantially higher than said central section;
a cannula comprising a distal portion extending through said septum lower section and a proximal portion disposed centrally in said upper septum section, adjacent an upper surface thereof; and
a needleless septum sampling device comprising a sample container, having, at one end, a puncturable, self-sealing element sealingly fixed thereto, wherein said puncturable, self-sealing element has a profile corresponding to that of the further recessed region surrounding said substantially recessed central section of said septum upper section, allowing the puncturable, self-sealing element to be inserted into the central section of said septum upper section and exert pressure on the upper surface of the central section of the septum, thereby allowing the cannula to protrude through the central portion of the septum and the puncturable, self-sealing element, allowing communication between an interior portion of an apparatus to be sampled and said sample container.

17. The needleless septum and sampling device of claim 16 wherein said cannula further comprises a section of substantially larger diameter than a body thereof, said section of substantially larger diameter positioned adjacent said proximal end of said cannula and within said septum, wherein said section of substantially larger diameter serves to resist motion of said cannula relative to said septum during sampling.

18. The needleless septum and sampling device of claim 16 wherein said distal portion of said cannula is substantially centered within a flow path of an interior volume of said apparatus to be sampled.

19. The needleless septum and sampling device of claim 16 wherein said septum upper section is harder than said septum lower section.

20. The needleless septum and sampling device of claim 16 wherein said sample container is evacuated.
